(19) United States
(12) Patent Application Publication
(10) Pub. No.: US 2025/0296890 A1
(43) Pub. Date: Sep. 25, 2025

(54) GENERATING TEMPERATURE INVERSION WITHIN A POROUS PREFORM USING MICROWAVES FOR CHEMICAL VAPOR INFILTRATION

(71) Applicant: UT-Battelle, LLC, Oak Ridge, TN (US)

(72) Inventors: Wenjun Ge, Knoxville, TN (US); Vimal A. Ramanuj, Knoxville, TN (US); Ramanan Sankaran, Knoxville, TN (US); Ying She, East Hartford, CT (US); Zissis Dardas, East Hartford, CT (US)

(21) Appl. No.: 19/085,164

(22) Filed: Mar. 20, 2025

Related U.S. Application Data
(60) Provisional application No. 63/567,910, filed on Mar. 20, 2024.

(51) Int. Cl. C04B 41/45; C04B 35/10; C04B 35/468; C04B 35/565; C04B 35/622; C04B 41/00; C04B 41/91

(52) U.S. Cl. CPC C04B 41/457; C04B 35/10; C04B 35/468; C04B 35/565; C04B 35/62222; C04B 41/0045; C04B 41/91; C04B 2235/3217; C04B 2235/3236; C04B 2235/3826; C04B 2235/614; C04B 2235/658

(57) ABSTRACT

A system and a method for densifying a porous preform are provided. The porous preform has a first surface and a second surface opposite to the first surface. A reflective layer is associated with at least one of the first surface or the second surface. A microwave source, under the control of one or more processors is configured to emit microwaves in at least one wavelength via a waveguide connected between the microwave source and a reactor into the porous preform either via the first surface or the second surface. The microwaves cause a temperature midway between the first surface and the second surface to be larger than the temperature at the first surface and the second surface by a value while at least one precursor gas flows in a chamber of the reactor. The reflective layer(s) has/have proprieties to cause the microwaves to have a phase shift of 180°.

### CROSS-REFERENCE TO RELATED APPLICATIONS

This application claims the benefit of U.S. Provisional Application No. 63/567,910 filed on Mar. 20, 2024, which is incorporated by reference herein in its entirety.

### STATEMENT REGARDING FEDERALLY SPONSORED RESEARCH OR DEVELOPMENT

This invention was made with Government support under DE-AC05-00OR22725 awarded by US Department of Energy. The Government has certain rights to this invention.

### BACKGROUND

Ceramic Matrix Composites (CMC) are a class of composite materials suitable for light weight and high temperature applications, including aerospace applications and power industries. However, consistent manufacturing of a CMC remains a challenge. One method for manufacturing a CMC is Chemical Vapor Infiltration (CVI). In the CVI process, reactive gases diffuse and react with a porous preform. At high temperatures, the gases undergo a chemical transformation leading to deposition of a solid ceramic phase on the pore-scale surface area. This results in a densification of the porous preform. Density refers to the complement of the porosity or the solid volume fraction in the preform.

A known CVI operates as an isothermal-isobaric process meaning that both the precursor gases and the preform are heated and maintained at the reaction temperature under a reduced pressure. The temperature and pressure may be reaction specific. In some known examples, the reaction temperature may be about 900-1100° C. and the reduced pressure may be about 1-100 kPa. In other known examples, the reaction temperature and the pressures may be 1100-1200° C. and a pressure may be about 100-200 kPa.

A common problem with CVI is the premature closure effect and non-uniformity of the densification. This is due to competing effects of chemical kinetics and reagent transport. As the reactive gases are transported into the porous preform, its outer region experiences higher concentration of reagents compared to the center. Consequently, the local deposition and surface growth are faster, leading to the occlusions (premature pore closure) which further reduces the transport of gases into the center. This leads to non-uniform densification where the surface has a high density than the center.

Additionally, in a known CVI, the heated gases undergo pyrolysis before reaching the preform surface. The preform is also subject to surface heating and heat is transferred to the core by diffusion causing a temperature gradient such that the outer surface is hotter than the center. This also causes the reaction at the surface to be faster than in the center.

To avoid a premature pore closure, the temperature and pressure may be reduced; to slow down the reaction at the surface, but this increases the processing time. For example, the processing time may be on the order of 600 to 2000 hours. This processing time is not commercially expedient.

Microwave heating has been proposed to combat the premature pore closure problem. Microwaves are able to heat a structure volumetrically. As such, a microwave-CVI process may be able to heat the preform up inside-out.

Certain experiments in this field have noted that reproducibility of the densification across samples is lacking. This is because a microwave-CVI process involves coupled chemistry and physics at multiple levels. Additionally, when an incident microwave interferes with its reflection, the wave-shape heating pattern is different from known heating methods in the CVI process. Additionally, the experiments used limited shapes for the analysis.

Moreover, as the CVI process proceeds, the properties of the preform change, further complicating the process.

### SUMMARY

Accordingly, disclosed is a manufacturing system comprising a reactor, a microwave source and one or more processors. The reactor comprises a chamber, at least one gas inlet and a gas outlet. The chamber is configured to hold at least one porous preform. Each porous preform has a first surface and a second surface opposite to the first surface. The reactor also has a means to associate a reflective layer on at least one of the first surface or the second surface. Each gas inlet is configured to deliver a precursor gas to the chamber. The microwave source is configured to emit microwaves in at least one wavelength. A waveguide is connected between the microwave source and the reactor. The waveguide is positioned to enable the microwaves to enter each porous preform either at the first surface or the second surface. The one or more processors is/are configured to control a gas flow rate of each precursor gas through the at least one gas inlet; and control the microwave source based on properties of a porous preform to create a temperature inversion within the porous preform such that a temperature midway between the first surface and the second surface is larger than the temperature at the first surface and the second surface by a value while the at least one precursor gas flows in the chamber.

In an aspect of the disclosure, the reflective layer has properties to cause the microwaves to have a phase shift of 180°.

In an aspect of the disclosure, the reflective layer may be removably attached to the means.

In an aspect of the disclosure, the system may further comprise a plurality of reflective layers which is selectable based on the porous perform.

In an aspect of the disclosure, the means associates a reflective layer with both the first surface and the second surface.

In an aspect of the disclosure, the microwave source may be configured to emit microwave in one of a plurality of available wavelengths. In this aspect of the disclosure, a wavelength for emission may be selected to achieve a characteristic wavelength of a resonant mode within the porous preform. The characteristic wavelength has predetermined proportion to a thickness of the porous preform (T) between the first surface and the second surface. The characteristic wavelength of the resonant mode within the porous preform is based on a permittivity εₚ of the porous preform. In an aspect of the disclosure, one or more processors are configured to change the selected wavelength for emission to reduce a change of the characteristic wavelength as the permittivity εₚ of the porous preform changes during a densification of the porous preform.

In an aspect of the disclosure, the chamber may further comprise a heater configured to heat each porous preform such that the first surface or the second surface is at a temperature. The temperature is based on properties of each porous preform.

In an aspect of the disclosure, the system may further comprise a pressure regulator configured to control the pressure within the chamber to reach the predetermined pressure.

In an aspect of the disclosure, the means for associating may be one or more mechanical arms.

Also disclosed is a method for densifying a porous preform. The method comprises obtaining the porous preform. The porous preform has first surface and a second surface in a first direction. The first surface and the second surface are separated by a distance (T) in the first direction. The porous preform comprises a ceramic that is reactive with chemical vapor infiltration (CVI) precursor gases. The ceramic has a porosity Φₚ and a permittivity εₚ; The method also comprises associating a reflective layer with at least one of the first surface or the second surface. Each reflective layer has a thickness (tᵣ) which is much less than the distance. Each reflective layer comprises a material that is non-reactive to the CVI precursor gases, has a porosity Φᵣ and a permittivity εᵣ. The porosity Φᵣ of each reflective layer is larger than the porosity Φₚ of the ceramic and the permittivity εᵣ of each reflective layer is larger than the permittivity εₚ of the ceramic such that microwaves are caused to have a phase shift of 180°. The method further comprises controlling a flow rate of the precursor gases into the CVI reactor to cause the precursor gases to diffuse inside the porous preform; and controlling a microwave source to emit microwaves having a wavelength λₘ and direct the microwaves toward either the first surface or the second surface of the porous preform, which is positioned in a CVI reactor, whereby the microwave enter an inside of the porous preform and form a resonant mode which creates a temperature inversion such that a temperature midway between the first surface and the second surface is larger than the temperature at the first surface and the second surface by a value.

In an aspect of the disclosure, the method may further comprise heating the CVI reactor to a temperature such that the temperature of the first surface or the second surface is a first temperature which is based on the porous perform and the precursor gases.

In an aspect of the disclosure, the distance T may be set such that a characteristic wavelength of the resonant mode within the porous preform responsive to the wavelength λₘ is a predetermined proportion. In an aspect of the disclosure, the method may further comprise cutting and/or stacking the porous preform at a time during the method to reduce a change in the characteristic wavelength of the resonant mode within the porous preform responsive to the wavelength λₘ.

In an aspect of the disclosure, the wavelength λₘ may be set such that a characteristic wavelength of the resonant mode within the porous preform responsive to the wavelength λₘ is a predetermined proportion of the distance T. In an aspect of the disclosure, the method may further comprise changing the set wavelength λₘ during a densification to reduce a change in the characteristic wavelength of the resonant mode within the porous preform.

In an aspect of the disclosure, when one reflective layer is used, such as associated with the first surface, the microwaves are directed to the second surface.

In an aspect of the disclosure, the associating a reflective layer with at least one of the first surface or the second surface may comprise selecting a first reflective layer from a plurality of prefabricated reflective layers based on the porous preform and the precursor gases and attaching the selected first reflective layer to a structure within the CVI reactor to hold the first reflective layer in contact with the first surface or the second surface of the porous preform. In an aspect of the disclosure, the associating further comprises selecting a second reflective layer from the plurality of prefabricated reflective layers based on the porous preform and the precursor gases and attaching the selected second reflective layer to a structure within the CVI reactor to hold the second reflective layer in contact with the other of the first surface or the second surface of the porous preform.

In an aspect of the disclosure, one the first reflective layer or the second reflective layer comprises an anti-reflective coating on a surface in which the microwaves enter. The anti-reflective coating may be formed from a powder Al₂O₃.

In an aspect of the disclosure, the preform may comprise SiC and the reflective layer may comprise BaTiO₃ or TiO₂.

### BRIEF DESCRIPTION OF THE DRAWINGS

FIG. 1A illustrates a diagram of a microwave chemical vapor infiltration (M-CVI) system in accordance with aspects of the disclosure;

FIG. 1B illustrates a diagram of another M-CVI system in accordance with aspects of the disclosure;

FIG. 2 illustrates a flow diagram of a M-CVI method in accordance with aspects of the disclosure;

FIGS. 3A-3D illustrate different methods of obtaining a preform in accordance with aspects of the disclosure;

FIG. 4A illustrates a flow diagram of a method for associating a reflective layer with at least one surface of a preform in accordance with aspects of the disclosure;

FIG. 4B illustrates a flow diagram of another method for associating a reflective layer with at least one surface of a preform in accordance with aspects of the disclosure;

FIG. 5A illustrates a sectional view of a preform with a reflective layer associated with one surface in accordance with aspects of the disclosure and also shows microwaves entering the preform via the other side;

FIG. 5B illustrates a sectional view of a preform with reflective layers associated with a first surface and a second surface in accordance with aspects of the disclosure and also shows microwaves entering the preform via the first surface;

FIG. 6A illustrates a sectional view of an alternate reflective layer(s) in accordance with aspects of the disclosure and FIG. 6B illustrates a top view of the alternate reflective layer;

FIG. 7 illustrates a flow diagram of a method of controlling a microwave source in accordance with aspects of the disclosure;

FIG. 8A illustrates a flow diagram of a method for monitoring the M-CVI process and continued control in accordance with aspects of the disclosure;

FIG. 8B illustrates a flow diagram of another method for monitoring the M-CVI process and continued control in accordance with aspects of the disclosure;

FIG. 9 illustrates a flow diagram of another M-CVI method in accordance with aspects of the disclosure; and

FIG. 10 illustrates a comparison of the spatial distribution of the microwave energy within a preform with and without reflective layers and shows different permittivity of a reflective layer.

### DETAILED DESCRIPTION

In accordance with aspects of the disclosure, microwaves are used to heat a preform in combination with one or more reflective layer(s) being associated with a first surface and a second surface of the preform to cause a peak of a standing wave (resonant mode) to be at or near the center of the preform in the z-direction (the thickness direction). The first surface and the second surfaces are end surfaces of the preform in the z-direction. A standing wave is formed when reflected waves travel in opposite direction with a same wavelength (and frequency) as the incident wave.

In an aspect of the disclosure, the reflective layer(s) are unique and customized for a particular set of precursors gases and preform. This is because each reflective layer should be chemically inactive so that it remains porous to allow the reactive gas regents to transport relatively unaffected. Since a number of different gas reagents may be used depending on the final target CMC, different reflector layers may be used depending on the same.

In an aspect of the disclosure, each reflective layer may also have a higher permittivity εᵣ than the permittivity εₚ of the preform. Permittivity is a measure of the ease of electrical polarization in response to an external electric field. The higher permittivity in the reflective layer is to achieve a phase shift of 180°. The relative permittivity impacts the amount of the phase shift. The amount of the phase shift is a function of the relative impedance. The impedance is based on the magnetic permeability μ, the permittivity ε, and the angular frequency ω of the microwave. Permittivity has a real and imaginary component as follows:

$$ε = {ε}^{′} - {ε}^{″} j \qquad ( 1 )$$

where ε′ represents the real part and ε″ represents the imaginary part.

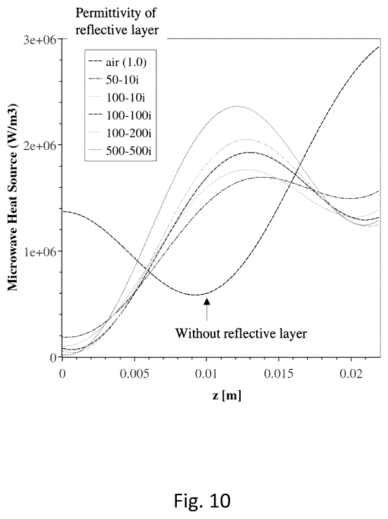

The phase shift as noted above is what enables the shift of the peak of the standing wave to the center. In some aspects of the disclosure, the real relative permittivity ε′ of the reflective layer(s) may be 10× higher than the real relative permittivity ε′ of the preform. However, the relative real permittivity between the reflective layers and the preform is not limited to 10× and 10× is for descriptive purposes only. The same applies to ε″. Each reflective layer effectively alters the dielectric properties at the surface (first surface or second surface). FIG. 10 illustrates an example of the effective of the permittivity εᵣ of a reflective layer and the spatial distribution of the energy within a preform. 5 different permittivity εᵣ are shown and compared with no reflective layer. In FIG. 10, two reflective layers were simulated. As can be seen at about 0.01 m within the preform, without the reflective layer(s), the energy is a minimum. However, with the use of the reflective layer(s), the energy pattern is substantially reversed. Further, as can be seen, the higher permittivity εᵣ, the higher the peak energy within the preform is at the same depth. For example, for 500-500i, the energy is higher than for 50-50i.

In an aspect of the disclosure, in order to keep each reflective layer from absorbing the microwaves (minimize), a reflective layer is targeted to be relative thinner than the preform. This also avoid heat loss which is a function of both the imaginary and real part of the permittivity.

$$Tan δ = {ε}^{″} / {ε}^{′} \qquad ( 2 )$$

In some aspects of the disclosure, the thickness of a reflective layer may be 10% of the thickness of the preform (T). In some aspects of the disclosure, the thickness of a reflective layer may be 5% of the thickness of the preform. In some aspects, the thickness may be a function of the εᵣ and εₚ, where the larger the difference the thinner a reflective layer may be.

In an aspect of the disclosure, a reflective layer may also have a higher porosity Φᵣ, than the porosity of the preform Φₚ (and pore size). The higher porosity in the reflective layer is also to avoid the precursor gases from encountering any additional resistance in the reflective layer preventing the same from accessing the center of the preform. For example, the initial porosity of the preform Φₚ may be about 80% and the porosity of the reflective layer(s) may be about 90% or higher.

Since the properties of the preform will change during the M-CVI process (over time), in an aspect of the disclosure, different reflective layer(s) may be used throughout the M-CVI process to maintain a difference between εᵣ and εₚ and Φᵣ, and Φₚ. Different properties of the preform may change by a different amount and percentage. For example, the permittivity εₚ (or porosity Φₚ) of the preform may substantially change during the M-CVI process, while the permeability μₚ may only slightly change.

Additionally, a thickness of the preform T may be set to achieve a target ratio with one or more properties. For example, in a semi-infinity medium (such as a preform), the intensity of an electromagnetic wave decreases to approximately 1/e of its original value after penetrating a distance equal to a penetration depth Lₚ into a material.

$${L}_{p} = - 1 / IM ( k ) \qquad ( 3 )$$

where k is a complex wave number defined as

$$k = ω √ μ ε \qquad ( 4 )$$

where ω is the angular frequency and μ is the permeability.

The angular frequency ω, permeability μ and permittivity ε of a material are a function of the wavelength (frequency) of the emitted electromagnetic wave (e.g., microwaves).

When an electromagnetic wave is mostly absorbed by a material, such as a preform, before being reflected, i.e., where a thickness is much greater than Lₚ, no standing wave is formed within the preform. Accordingly, in an aspect of the disclosure, the preform thickness T may be set to less than 2Lₚ.

Additionally, the preform thickness T may be set to have a target ratio with respect to a characteristic wavelength λ_{c}.

$${λ}_{c} = 2 π / Real ( k ) \qquad ( 5 )$$

where k is defined above at eq 4.

In an aspect of the disclosure, the thickness T may be set to 0.5λ_{c}. In other aspects, the thickness T may be set to 1.0λ_{c}.

Since the properties of the preform will change during the M-CVI process (over time), including permeability μₚ and permittivity εₚ (or porosity Φₚ), in an aspect of the disclosure, the thickness of the preform T may change throughout the M-CVI process.

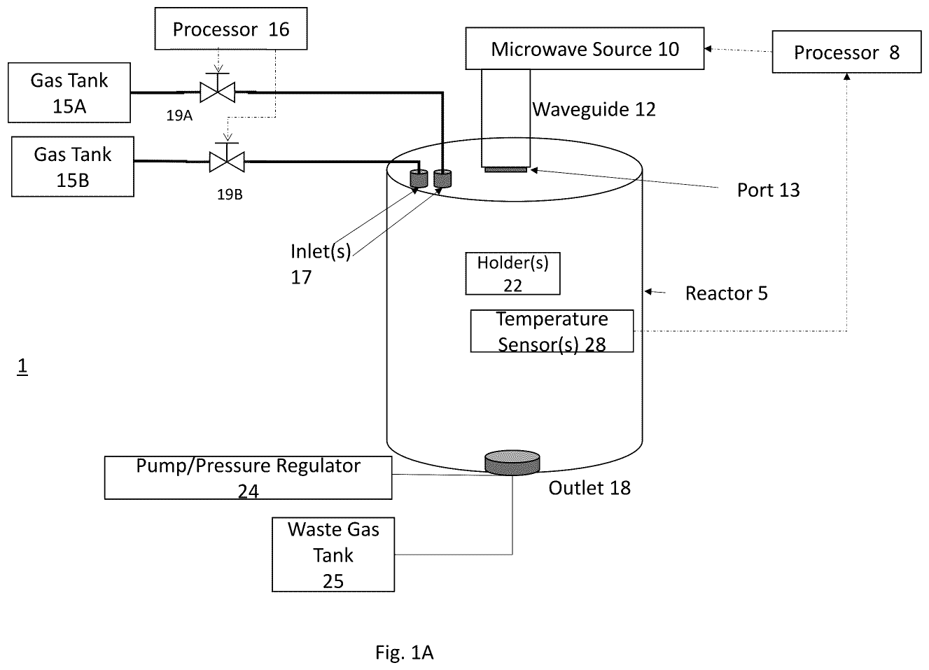

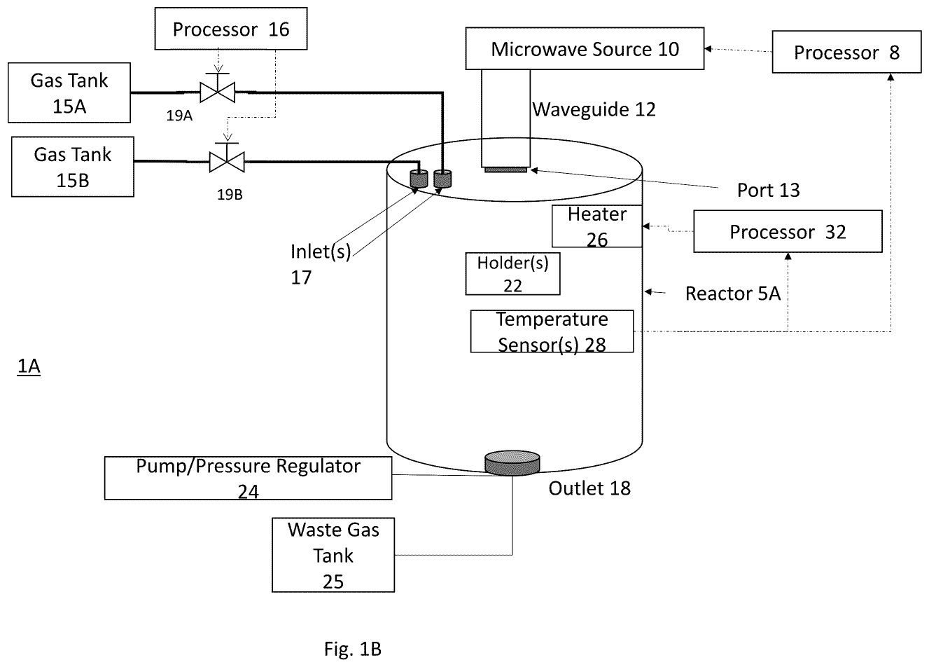

FIG. 1A is diagram of a microwave Chemical vapor infiltration (M-CVI) system 1 in accordance with aspects of the disclosure. The M-CVI system 1 includes a microwave source 10. In some aspects, the microwave source 10 may include a magnetron and a power source. A magnetron typically emits microwaves having a set frequency. For example, a magnetron may emit microwaves at 2.45 GHz. (center frequency). A magnetron may also emit frequencies +−x MHz from the center. In some aspects, the microwave source 10 may include a filter or tuner to limit the emitted frequencies to the center frequency. Additionally, in some aspects, since the microwave source 10 may continuously emit the microwaves for an extended period of time, e.g., hours, the microwave source 10 may also comprise a cooling system to regulate the temperature of the vacuum tube and other circuit components within the microwave source 10. The cooling system may include water cooling.

In other aspects of the disclosure, the microwave source 10 may include a solid-state microwave generator. The solid-state microwave generator provides an additional degree of freedom. This is because, unlike a typical magnetron, the solid-state microwave generator may be configured to emit microwaves at a plurality of different frequencies (wavelengths). In some aspects, the different frequences may be discrete and spaced apart within an authorized ISM band such as in the L-Band and/or the S-band. For example, the L-Band include 902-928 MHz and the S-band includes 2.4 to 2.5 GHz. Other bands may be used such as a 5.8 GHz.

The solid-state microwave generator may include GaN. In other aspects, the plurality of different frequencies may be continuous.

By allowing for the frequency of the microwave source 10 to be changed (e.g., selected), the M-CVI system 1 can be used for different thicknesses of the preform T and still achieve the above target ratios. For example, instead of setting a thickness of the preform T based on the frequencies of the magnetron, the thickness of the preform T may be set as desired and the frequencies of the microwave source 10 may be changed to achieve the above target ratios.

A waveguide 12 may be connected to the output of the microwave source 10. The other end of the waveguide 12 has a port 13. In some aspects, the port 13 may be formed from quartz. The port end of the waveguide 12 may be mounted to the top of the reactor 5. The top of the reactor 5 has a corresponding opening. In some aspects of the disclosure, the opening (and port 13) is positioned at the center of the top of the reactor 5. The waveguide 12 may be dimensioned based on the range of emitted frequencies.

The size of the port 13 (in the x and y direction) may be based on the target size of the preform 500 (in the x and y direction). To achieve a uniform delivering of the microwaves 510 into the preform 500, the size of the port 13 in the x and y direction needs to be the same or larger than the target size of the preform 500 in the x and y direction. Additionally, when the preform 500 is inserted into the reactor chamber, the position of the preform 500 is such that it is aligned with the port 13 as viewed from the z-direction. This because the microwaves 510 should be perpendicular to the first surface of the preform 500.

In some aspects of the disclosure, if the reactor 5 holds more than one preform 500 at a time, the waveguide 12 may have multiple output ports 13. For example, the waveguide 12 may have split paths with the terminus of each path having its own dedicated port 13. In this case, the top of the reactor 5 may comprises a plurality of openings to align with each dedicated port 13. Similarly, each preform 500 may be aligned as viewed in the z direction with the dedicated port 13. Unlike a known CVI system, in the M-CVI system 1, the multiple preforms 500 will typically not be processed in different rows. This is because during the M-CVI process, the microwaves 510 will enter one preform 500 and be absorbed. If the preforms 500 are separated into different rows in the reactor 5, the preform 500 at the bottom would not be exposed to any microwaves 510.

The microwave source 10 may be controlled by processor 8. The processor 8 may be a microcontroller or microprocessor or any other processing hardware such as a field programmable gate array (FPGA). The processor 8 may control the microwave source 8 to turn ON/OFF, the power level, and in a case where there are multiple available frequencies, control the frequency.

The power of the microwaves impacts: (1) the reaction time; (2) the amount of the temperature inversion (ΔT) and (3) the temperature at the surface (Ts). The temperature at the surface (Ts) is important because if it is too high, premature pore closure will occur. Ts dictates how fast the surface will densify. The power level of the microwaves 510 may be based on the material of preform, and the precursor gases. Different materials have different reactions at different temperatures.

In some aspects of the disclosure, the processor 8 controls the power to achieve a ΔT greater than a predetermined value such that densification may occur inside out and at the same time have Ts less than a predetermined temperature. These values and temperatures may be specific reaction based. For example, in some aspects, ΔT may be greater than 20° C. In other aspects, ΔT may be greater than 30° C. In other aspects, ΔT may be greater than 50° C. ΔT needs to be high enough to overcome the difference in the amount of the gases at the center v. surface (e.g., transport). In some aspects, the Ts may be kept about 900° C. In other aspects, depending on the preform 500 and precursor gases, the Ts may be kept about 925° C. In other aspects, for a different set of precursor gases and preforms, the surface temperature Ts may be 500° C.

The thermal conductivity κₚ of the preform 500 also changes during the densification. For example, at a higher porosity Φₚ (smaller κₚ), a larger temperature gradient within the preform 500 may be achieved for the same power level and frequency than when the preform 500 becomes denser (larger κₚ).

The reactor 5 has one or more holder(s) 22. The holder(s) 22 are configured to hold the reflective layer(s) 505A, 505B in association with a preform 500. For example, the holder(s) 22 may be a mechanical arm. The mechanical arm may have fingers for holding the edges of a reflective layer 505A, 505B (in either the x-direction or the y-direction). In a case where two reflective layers 505A, 505B are used, there may be two mechanical arms, one for reflective layer 505A and the other for reflective layer 505B. The preform 500 may be inserted between the reflective layers 505A, 505B, e.g., sandwich. The mechanical arms holding the reflective layers 505A, 505B effectively exert upward/downward pressure on the preform 500 which holds the preform 500 in place. Therefore, the holders 22 are configured to associate the reflective layers 505A, 505B with the preform 500.

In a case where only one reflective layer 505A is used, there may be only one mechanical arm. For example, the reflective layer 505A may be below the preform 500 and the preform 500 sits on the reflective layer 505A and held in place using gravity.

The holder(s) 22 may also be non-reactive to the precursor gases. Additionally, the holder(s) 22 may also not be thermally conductive such as heating when exposed to the microwaves. Additionally, the holder(s) 22 should not be a good electrical conductor. For example, the holder(s) 22 may be glass or plastic.

The M-CVI system 1 also has one or more gas tanks 15A, 15B . . . . Two are shown for illustrative purposes. Each gas tank 15A, 15B may have a precursor gas. A precursor gas may be a gaseous ceramic precursor. The precursor gas depends on the target CMC and preform 500. For example, the precursor gas may include methyl trichlorosilane (MTS) and hydrogen (H₂). The combination of the same may diffuse into a porous preform 500 and react to form SiC in a SiC porous preform.

Each gas tank 15A. 15B may be respectively connected to a controllable valve 19A, 19B. The valves 19A, 19B may be controlled by a processor 16. The processor 16 may be a microcontroller or microprocessor or any other processing hardware such as a field programmable gate array (FPGA. The processor 16 may be the same or different from the processor 8 which controls the microwave source 10. The processor 16 may control the valve 19A, 19B to cause the precursor gases to flow from the gas tank 15A, 15B (or not). Additionally, the processor 16 may control the gas flow rate. In an aspect of the disclosure, the gas flow rate may be higher than the known CVI system. This is to cool the surface of the preform 500 via forced convection heating/cooling. The convection heating/cooling of the surfaces reduces the premature pore closure.

The precursor gases may enter the reactor 5 via inlet(s) 17. FIG. 1A illustrates separate inlets 17 for each precursor gas.

Additionally, in an aspect of the disclosure, since microwaves 510 are used to volumetrically heat the preform 500, the precursor gases pyrolyze upon entering the preform 500 as opposed to within the reactor chamber prior to entrance as in a known CVI system.

Gases leave the reactor 5 via outlet 18 into a waste gas tank 25.

In an aspect of the disclosure, the M-CVI system 1 also comprises a pump/pressure regulator 24 configured to maintain a target pressure within the reactor 5. The target pressure may be different for different reactions and preforms 500. For example, in some aspects of the disclosure, the target pressure may be about 1-100 kPa. In other aspects, the target pressure may be about 100-400 kPa. In some aspects, the target pressure may be higher than known CVI systems due to the use of microwaves which achieves the temperature inversion. A higher pressure may speed up the reaction; however, since the microwaves achieve the temperature inversion, even though the pressure may be higher, since the densification occurs inside out, the higher reaction rate may not materially impact the quality of the densification. A processor may control the pump. This processor may be same or different than processor(s) 8, 16.

In an aspect of the disclosure, the reactor 5 may also have a temperature sensor(s) 28. The temperature sensor(s) 28 may detect the temperature within the preform 500 (both at the surface and in the center). In some aspects, the temperature sensor(s) 28 may be an Infrared sensor such as in an IR camera. In this aspect of the disclosure, the IR camera may cause a thermal image of the preform 500 to be displayed on a display (not shown). The M-CVI system 1 may also have a human-machine interface (HMI) which can be used by an operator to adjust the control of the microwave source 10 based on the thermal image. The HMI interacts with the processor 8. In other aspects, the processor 8 may automatically control the microwave source 10 based on feedback from the temperature sensor(s) 28.

In an aspect of the disclosure, the system 1 may also comprises a plurality of reflective layer(s) 505A, 505B which are prefabricated. Multiple reflective layers 505A (such as for the bottom of the preform 500) may be prefabricated in different thicknesses Tᵣ, different porosities Φᵣ and different permittivity εᵣ. Multiple reflective layers 505B (such as for the top of the preform 500) may be prefabricated in different thicknesses Tᵣ, different porosities Φᵣ and different permittivity εᵣ. In an aspect of the disclosure, a reflective layer 505B for the top of the preform 500 may also comprise an anti-reflective coating 512. The anti-reflective coating 512 is configured to prevent the microwaves from hitting the reflective layer 505B and reflecting away from the preform 500. Since the microwaves are emitted from above the preform 500 and will enter via the top, there is no need for the reflective layer 505A (on the bottom) to have the anti-reflective coating. In an aspect of the disclosure, the anti-reflection coating 512 can be one layer or multiple layers of Alumina (Al₂O₃) powders.

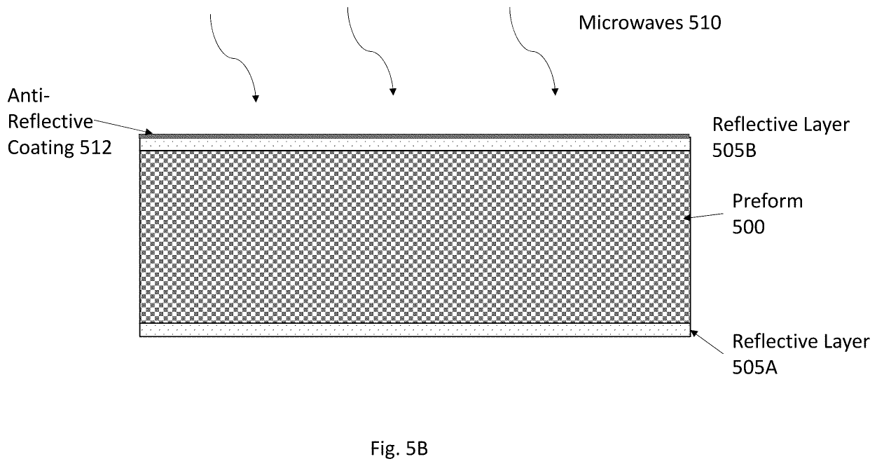

FIG. 5A illustrates an example of a preform 500 associated with one reflective layer (reflective layer 505A) at the bottom surface. In this example, the microwaves 510 enter the top surface (surface opposite the reflective layer 505A).

FIG. 5B illustrates an example of a preform 500 associated with two reflective layers 505A, 505B. Reflective layer 505A is associated with a bottom surface of the preform 500 and reflective layer 505B is associated with a top surface of the preform 500. Reflective layer 505B has the anti-reflective coating 512.

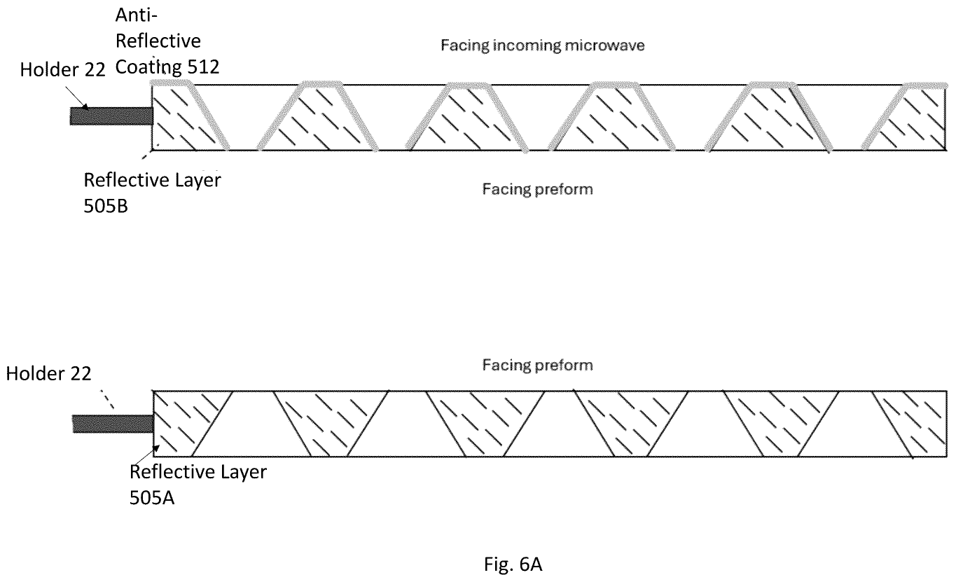

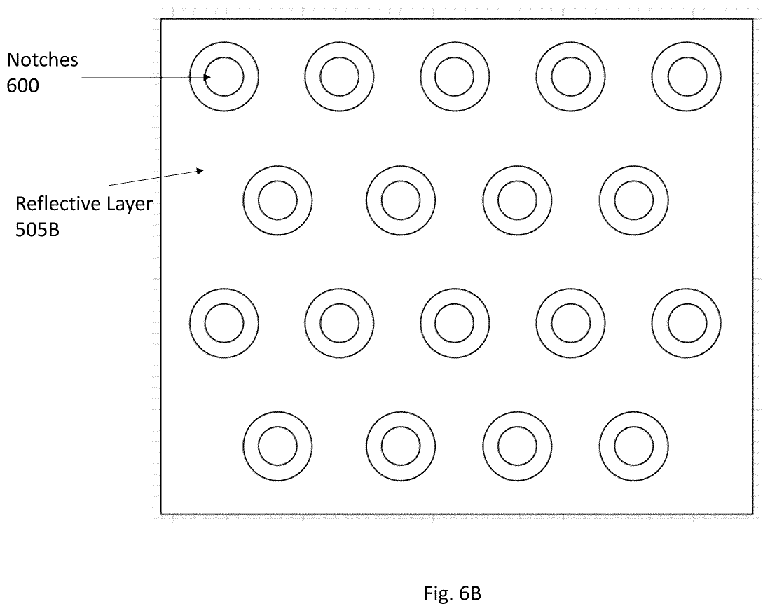

In an aspect of the disclosure, a reflective layer (i.e., reflective layer 505B) may cover the entire top surface of the preform 500 such as shown in FIG. 5B. However, in other aspects of the disclosure, the reflective layer 505B may have gaps or notches 600 in the reflective layer 505B to expose a portion of the surface of the preform 500 to the microwaves 510 (directly) without first entering the reflective layer 505B. The notches 600 may be angled such that the surface area at the top of the reflective layer 505B is smaller than the surface area at the bottom of the reflective layer such as shown in the cross-sectional view in FIG. 6A. The notches 600 in the reflective layer 505B also will serve to directly expose a portion of the surface of the preform 500 to the precursor gases without have the precursor gases travel through the reflective layer 505B. This may also achieve better convection cooling via the gas flow in the exposed areas.

FIG. 6B illustrates a top view showing the notches 600.

FIG. 1B illustrates another M-CVI system 1A in accordance with aspects of the disclosure. The difference between the M-CVI system 1A and M-CVI system 1 is that in M-CVI system 1A there is a heater 26 separate from the microwave source 10. This heater 26 is configured to heat the reactor 5A (chamber). The heater 26 may be the same type as used in a known CVI reactor. For example, the heater 26 may be resistive or inductive. The heater 26 may comprise one or more heating coils. In some aspects, the heater 26 may include graphene.

To avoid interferences with the microwaves 510, the heater 26 is offset of the line of sight between the port 13 and the preform 500 (as viewed from the z-direction).

Unlike the M-CVI system 1 in FIG. 1A, when a separate heater 26 is used, the precursor gases may be preheated prior to entering the preform 500. The heater 26 may be controlled by processor 32. The processor 32 may be a microcontroller or microprocessor or any other processing hardware such as a field programmable gate array (FPGA). The processor 32 may be the same or different from the processor 8 which controls the microwave source 10 (and processor 16 which controls the valves 19A, 19B). Similar to above, the reactor 5A may include temperature sensor(s) 28. Here, the temperature sensor(s) 28 may be connected to both processors 8 and 32 to provide feedback. The temperature sensor(s) 28 may be the same as above. Additionally, there may be a temperature sensor for detecting the air temperature, e.g., temperature adjacent to the preform 500.

The combined control of the microwave source 10 and the heater 26 sets the temperature Ts at the surface of the preform 500 and the temperature inversion ΔT.

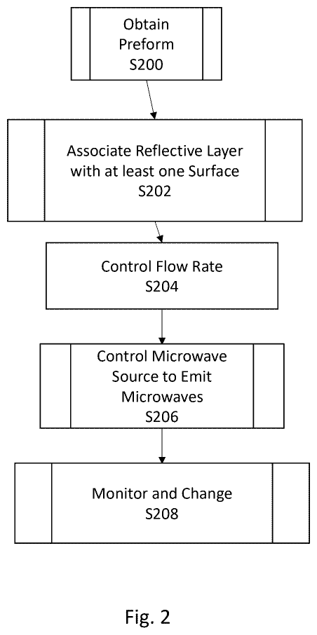

FIG. 2 illustrates a flow diagram of a M-CVI method in accordance with aspects of the disclosure. The M-CVI method in FIG. 2 may use the M-CVI system 1 illustrated in FIG. 1A.

At S200, the preform 500 is obtained. In some aspects, a prefabricated preform may be purchased at a specific thickness T. In accordance with this aspect, the prefabricated preform may come with a specification sheet having the thermal conductivity κₚ, the permeability μₚ and permittivity εₚ (both real and imaginary) and porosity Φₚ.

The preform 500 may include silicon carbide (SiC), ZiO₂, Si₃N₄, BN, TiC. B₄C and Al₂O₃. Additionally, the preform 50 may include carbon (C).

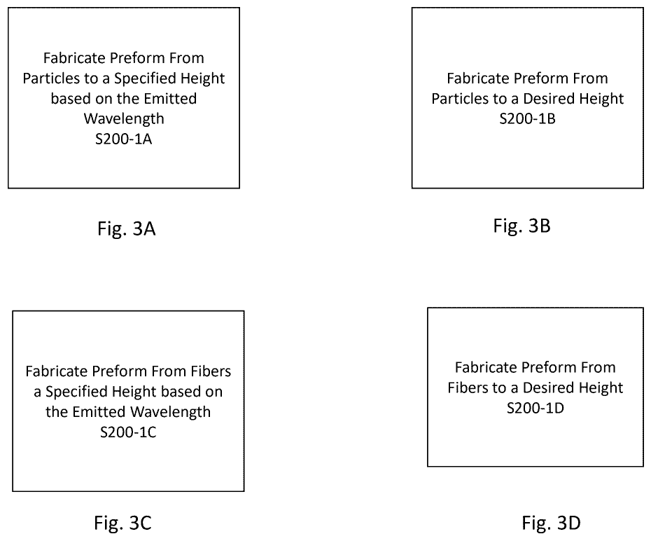

In other aspects, the preform 500 may be fabricated. The preform 500 may be fabricated from particles (S200-1A, FIG. 3A) or (S200-1B, FIG. 3B) or fabricated from a fiber (S200-1C, FIG. 3C) or (S200-1D, FIG. 3D).

For example, the preform 500 may be fabricated using an additive manufacturing technique using the particles. Alternative, fibers may be stacked, such as being pressed together or weaved. The particles or fibers for fabricating the preforms 500 may be acquired from a manufacturer. In some aspects, the bulk material manufacturer may include a specification sheet having certain properties of the material including the thermal conductivity κₚ, the permeability μₚ and permittivity εₚ (both real and imaginary). Both thermal conductivity κₚ and permittivity εₚ have temperature dependencies. Therefore, the initial estimation of these properties may be based on an average of the expected temperature at operation. Permittivity εₚ also depends on the frequency of the microwave and porosity. The porosity Φₚ of the preform may be estimated based on the mass and volume.

The thickness of the preform T may be based on the characteristic wavelength λ_{c} and penetration depth Lₚ, both of which are a function of one or more of the above properties and the emitted wavelength. In a case where the microwave source 10 has single main frequency capability, preform 500 may be fabricated to a specific height (S200-1A, FIG. 3A) or (S200-1C, FIG. 3C). For example, the single main frequency may be 2.45 GHz. The permittivity εₚ (both real and imaginary) may be determined for 2.45 GHz. Permeability μₚ may also be estimated. The angular frequency ω may be determined based on the microwave frequency. Based on the estimated properties, the penetration depth Lₚ is determined using eq 3 and the characteristic wavelength λ_{c} is determined using eq. 5. Based on the determined penetration depth Lₚ and the characteristic wavelength λ_{c}, the thickness of the preform T is specified to achieve predefined ratios thereof, e.g., less than 2Lₚ and about 0.5λ_{c}.

At S200-1C, the preform 500 may be fabricated by cutting the fibers and stacking (weaving) the same to achieve the thickness set above. Once stacked to the set thickness, the initial estimated properties may be reconfirmed.

Alternately, at S200-1A, the preform 500 may be fabricated to the set thickness from the particles using the additive manufacturing. The properties may be reconfirmed by measurement after fabrication.

In other aspects of the disclosure, in a case where the microwave source 10 can emit different main wavelengths (different frequencies), there is a greater flexibility in the thickness of the preform T. The target thickness in this case may be in a range of thicknesses. As described above, certain material properties are based on the frequency (wavelength of the emitted microwaves), the range of the thickness for the preform T may be estimated using the maximum available frequency and minimum available frequency of the microwave. For example, Lₚ and λ_{c}, may be estimated based on the material properties responsive to the maximum available frequency emitted from the microwave source 10 and Lₚ and λ_{c}, may be estimated based on the material properties responsive to the minimum available frequency emitted from the microwave source 10. Once the range of thickness is determined, the preform 500 may be fabricated to a desired thickness within this range at S200-1B, FIG. 3B (additive manufacturing) or S200-1D, FIG. 3D (stacking fibers).

At S202, the preform 500 (obtained in S200) is associated with at least one reflective layer (e.g., reflective layer 505A or reflective layers 505A, 505B).

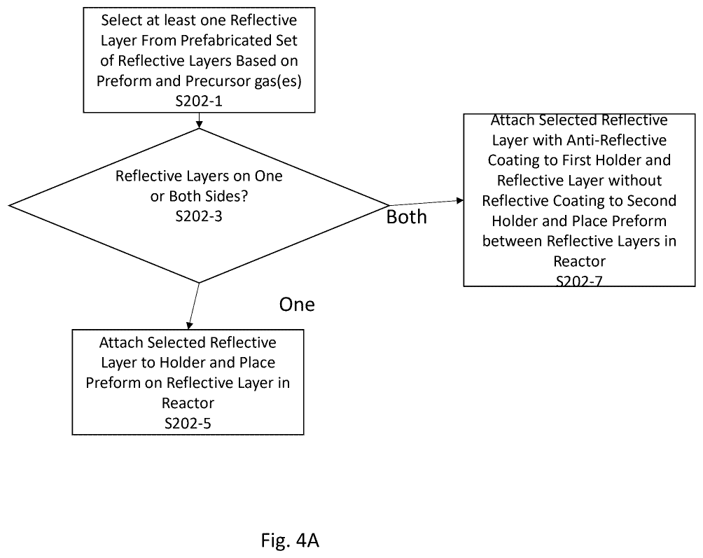

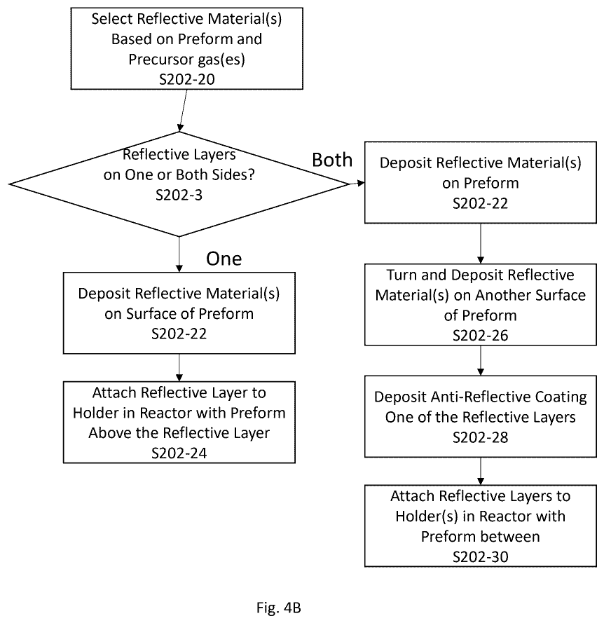

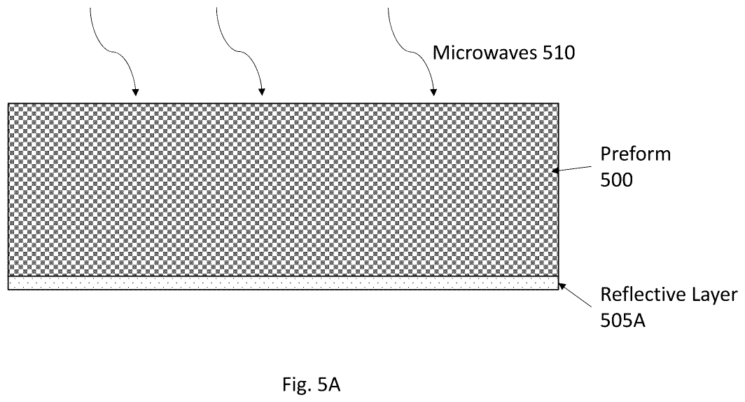

FIG. 4A illustrates a method for associating one or more reflective layers (e.g., reflective layer 505A or reflective layers 505A, 505B) with at least one surface of a preform 500 in accordance with aspects of the disclosure.

At S202-1, one or more reflective layers 505A, 505B are selected from a plurality of prefabricated reflective layers. A prefabricated reflective layer may be made of BaTiO₃. In other aspects, a prefabricated reflective layer may be TiO₂. In an aspect of the disclosure, this determination may also be based on the material of the preform 500 and the precursor gases. The temperature inversion achieved using one reflector layer (e.g., reflective layer 505A) may not be as large and the temperature inversion achieved using two reflective layers (e.g., reflective layers 505A, 505B). For some preforms 500 and precursor gases, a large temperature inversion may be needed to counter the premature closure and gas concentration gradient. However, for other preforms 500 and precursor gases, the reaction temperature may occur at a lower temperature and therefore, a premature closure may be reduced and therefore a lower temperature inversion may be sufficient.

As described above, the thickness of the preform T is known and certain properties of the preform 500 have been estimated such as the permittivity εₚ, and porosity Φₚ. The one or more reflective layers 505A, 505B may be selected such that the permittivity εᵣ, (both real and imaginary) is higher than permittivity εₚ, to achieve the targeted phase shaft. Similarly, one or more reflective layers 505A, 505B may be selected such that the porosity Φᵣ is higher than porosity Φₚ. Additionally, the one or more reflective layers 505A, 505B may be selected such that it/they are not reactive with the precursor gases (and the preform 500).

At S202-3, it is determined whether a reflective layer is to be associated with one (e.g., bottom) or both sides (e.g., top and bottom) of the preform 500 in a similar manner as described above. The association process here has a minimal impact on the closure of the pores, therefore, in an aspect of the disclosure, reflective layers 505A, 505B on both sides (top and bottom) may be used initially. Additionally, since the reflective layers 505A, 505B are associated by gravity and pressure, it is relatively easy to remove a reflective layer (e.g., reflective layer 505B) during the M-CVI process. When multiple reflective layers 505A, 505B are used, one of the reflective layers will have the anti-reflective coating 512 (e.g., reflective layer 505B).

In a case where both reflective layers 505A, 505B are used, reflective layer 505A is attached to a holder 22 at S202-7. The preform 500 is positioned on top of the reflective layer 505A. Reflective layer 505B is subsequently positioned on top of the preform 500. In some aspects, only one holder 22 may be used (for the reflective layer 505A). However, in other aspects, the reflective layer 505B may also be attached to a holder 22. The holder 22 may be the same or different. For example, the reflective layer 505A may be attached to a first holder and the reflective layer 505B may be attached to a second holder. The preform 500 is sandwiched between the reflective layers 505A, 505B. In an aspect of the disclosure, the force exerted by the holder(s) 22 maintain the preform 500 between the reflective layers 505A, 505B and enable contact.

In a case where one reflective layer 505A is used, reflective layer 505A is attached to a holder 22 at S202-5. The preform 500 is positioned on top of the reflective layer 505A.

FIG. 4B illustrates a method for associating the preform 500 with at least one reflective layer (e.g., reflective layer 505A or reflective layers 505A, 505B) in accordance with aspects of the disclosure. In this aspect of the disclosure, the one or more reflective layers 505A, 505B may be deposited on the preform 500 (to be later removed after the fabrication process). It is noted that the deposition of a reflective layer may impact the porosity of the preform 500 and cause closure of some of the pores.

In an aspect of the disclosure, due to the potential impact on the pore closure, a reflective layer may only be associated with the bottom of the preform 500 (reflective layer 505A) when the reflective layer 505A is deposited. In this case, S202-3 may be omitted.

In S202-20, the material used for the deposition of the reflective layer(s) may be selected. The materials may be selected based on their bulk properties such as the materials identified above.

The material for the reflective layer (such as reflective layer 505B) may depend on the material of the preform, the precursor gases as described above (e.g., non-reactive). Additionally, since the porosity Φₚ was estimated above, the material for the reflective layer may be selected and deposited in a manner to have a higher porosity with larger pores. Similarly, since the permittivity for the preform was estimate above, the material for the reflective layer may be selected and deposited in a manner to have a higher permittivity to achieve the target phase shift.

Further, since the thickness of the preform 500 is known, the thickness of the reflective layer 505B may also be set to be substantially smaller (e.g., 10%).

At S202-3, it is determined whether a reflective layer is to be associated with one (e.g., bottom) or both sides (e.g., top and bottom) of the preform 500.

In some aspects, S202-3 and S202-20 may be reversed since the decision in S202-3 may impact the material selection in S202-20.

In a case where one reflective layer 505A is used, the reflective layer 505A is deposited on a surface of the preform at S202-22 until the set thickness is achieved. The reflective layer 505A may be deposited as a thin film. The properties on the reflective layer 505A may be confirmed prior to insertion into the reactor 5. At S202-24, the reflective layer 505A and preform 500 may be moved from the thin film deposition chamber to the reactor 5 and attached to the holder 22. For example, the reflective layer 505A may be placed between the fingers of a mechanical arm such that the reflective layer 505A is below the preform 500.

In a case where reflective layers 505A, 505B are used, the reflective layer 505A is deposited on one surface of the preform at S202-22 in a similar manner as described above. The properties on the reflective layer 505A may be confirmed prior to depositing the other reflective layer 505B. Afterwards, the preform 500 may be turned and reflective layer 505B may be deposited on the opposite surface at S202-26.

At S202-28, an anti-reflective coating 512 is deposited on the reflective layer 505B. In some aspects, additive manufacturing may be used for depositing the anti-reflective coating 512. For example, 3D printing may be used to deposit Alumina (Al₂O₃) on the reflective layer 505B.

At S202-30, the preform 500 with the reflective layers 505A, 505B is positioned within the reactor 5 and attached to the holder(s) 22. In an aspect of the disclosure, one holder 22 may be used to hold the reflective layer 505A. In other aspects of the disclosure, one holder 22 may be used to hold each reflective layer 505A, 505B. For example, the reflective layers 505A, 505B may be stuck onto the holder 22 such as shown in FIG. 6A. In other aspects, the reflective layers 505A, 505B may be positioned between the fingers of a mechanical arm (in either the y direction or the x direction).

After the reflective layer(s) (e.g., reflective layer 505A or reflective layers 505A and 505B) are associated with the preform 500, microwave source 10 is turned ON by processor 8 and pump/pressure regulator 24 is turn ON and the valves 19A/19B is controlled to allow the precursor gases to enter the reactor 5 (by processor 16) at S204/S206. In some aspects, the microwave source 10 and the pump/pressure regulator 24 may be turned ON prior to the precursor gases being allowed to enter the chamber of the reactor. This is to achieve a set pressure within the reactor 5 and a targeted temperature inversion within the preform 500 prior to the precursor gases entering the chamber of the reactor 5.

The set pressure and the target temperature inversion (ΔT) (and surface temperature Ts) may be reaction specific (combination of preform 500 and precursor gases). Although not shown, the reactor 5 may also comprises a pressure sensor. In some aspects, the set pressure may be 1-100 kPa. In other aspects, the set pressure may be 1-400 kPa.

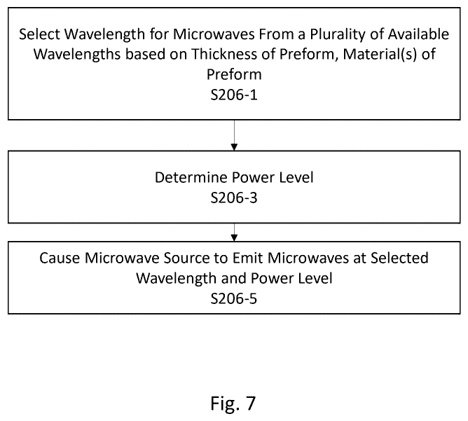

FIG. 7 illustrates a flow diagram of a method of controlling the microwave source in accordance with aspects of the disclosure. S206-1 is executed in a case where the microwave source 10 is configured to emit one of a plurality of main frequencies. At S206-1, the frequency/wavelength for emission by the microwave source 10 is selected. The frequency/wavelength is selected to obtain target ratios for the characteristic wavelength λ_{c} and penetration depth Lₚ to the thickness of the preform T. Both the characteristic wavelength λ_{c} and penetration depth Lₚ. are dependent on the emitted frequency (see Eqs. 3 and 5). In some aspects of the disclosure, characteristic wavelength λ_{c} and penetration depth Lₚ may be determined for each available frequency. Each calculated characteristic wavelength λ_{c} and penetration depth Lₚ may be then compared with the actual thickness of the preform T. The frequency is selected to achieve the target ratios, e.g., thickness which is about 0.5λ_{c} and less than about 2Lₚ.

In a case where the microwave source 10 is configured to emit one main frequency such as 2.45 GHZ, S206-1 may be omitted.

At S206-3, the power level needed for the M-CVI process is determined. The power level needed is reaction specific (combination of preform 500 and precursor gases). This is because different precursor gases achieve pyrolysis at different temperatures. In the M-CVI system 1 without a separate heater 26, the pyrolysis occurs at the top surface of the preform 500 (or near thereabout). This is because the air around the preform 500 is not heated by the microwaves 510. In an aspect of the disclosure, the power level for the microwave source 10 may be 9-50 W/cm² to (1) cause the pyrolysis of the precursor gases at the surface and (2) heat the preform to generate the temperature inversion. In some aspects of the disclosure, when two reflective layers 505A, 505B are used, the power level for the microwave source 10 may be higher to account for reflection from the top of the reflective layer 505B (even though the top has an anti-reflective coating 512.

The target surface temperature (Ts) may be based on a known temperature range for achieving pyrolysis for the precursor gases used. In order to reduce a likelihood of the premature pore closure, the target surface temperature (Ts) may be set to a lower end of the known temperature range.

The heat rate is a function of the properties of the preform 500 including density ρₚ, specific heat capacity cₚ, thermal conductivity κₚ and a convention coefficient h. The effect of the reflective layers 505A, 505B on heat transfer is minimal. The power level needed to achieve the target surface temperature (Ts) and temperature inversion ΔT may be determined based on a prior M-CVI process for a similar preform, modelling and/or simulations. The temperature inversion ΔT is also impacted by the reflective layer 505A, 505B.

At S206-5, the processor 8 causes the microwave source 10 to emit the microwaves using the determined power level in S206-3 (and set frequency in S206-1). In some aspects, the microwave source 10 may be turned ON prior to the valves 19A, 19B being controlled. This is to heat the preform 500 to the target surface temperature Ts and temperature inversion ΔT prior to the reaction. The temperature of the preform 500 may be detected by the temperature sensor(s) 28. Once the temperature of the preform 500 reaches the target surface temperature Ts and temperature inversion ΔT, processor 16 may control the valves 19A. 19B to allow the gases from gas tanks 15A, 15B to enter the reactor 5 at a set flow rate.

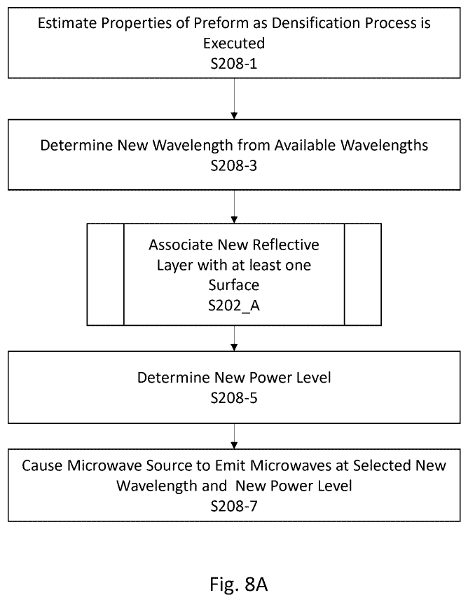

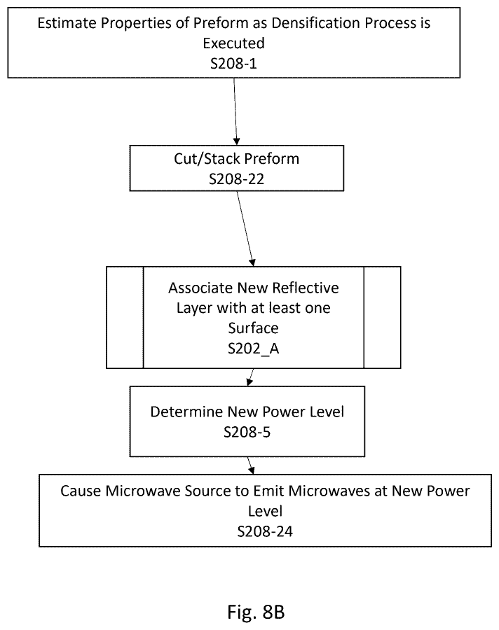

The M-CVI process is monitored at S208 to determine if changes are needed to the control of the microwave source 10 or to the reflective layer(s) 505A, 505B. FIG. 8A illustrates a flow diagram of a method for monitoring the M-CVI process and feedback control in accordance with aspects of the disclosure. At S208-1, the properties of the preform 500 are estimated. During the densification process, the thermal conductivity κₚ is expected to change because the porosity Φₚ changes and in particular, the thermal conductivity κₚ is expected to increase. This increase may be exhibited by a decrease in the temperature inversion ΔT which may be detected by the temperature sensor(s) 28. Additionally, periodically the M-CVI process may be stopped and the valves 19A, 19B closed and the microwave source 10 turned OFF. The preform 500 may be removed from the reactor 5 and x-rayed to evaluate the densification of the preform 500, e.g., to confirm that the densification is occurring inside out. The density of the preform 500 may be estimated by weighing the preform and determining the volume. A change in the permittivity εₚ (both real and imaginary) may be estimated for the current selected frequency. Since the preform 500 is getting denser, it is also expected that the permittivity will increase. Additionally, the permeability μₚ may also be estimated. It is expected that the permeability μₚ will decrease as the preform 500 become denser. The angular frequency ω for the current selected frequency of the microwave source 10 within the preform 500 may also be estimated.

Since permittivity εₚ (both real and imaginary), permeability μₚ (minimal change) and angular frequency ω change, k, the complex wave number is also expected to change per eq. 4. A change in k would cause a change in the characteristic wavelength λ_{c} and penetration depth Lₚ.

Accordingly, in an aspect of the disclosure, at S208-3, a new frequency from among the available frequencies for emission may be selected. For example, the new frequency for emission may be selected to minimize the change in the target ratios of the characteristic wavelength λ_{c} and penetration depth Lₚ to the thickness of the preform T. The new frequency may be selected in a similar manner as described above in S206-1.

Also, since the permittivity εₚ has changed, in order to maintain the reflective layer(s) 505A, 505B having a higher permittivity εᵣ to achieve the target phase shift, and porosity Φₚ has changed the reflective layer(s) 505A, 505B may be switched at S202_A. The original reflective layer(s) 505A, 505B may be removed from the holder(s) 22 and new reflective layer(s) 505A, 505B may be attached as described in FIG. 4A. In other aspects, the deposited reflective layer(s) may also be removed. For example, the reflective layer may be cut off. A new reflective layer(s) 505A, 505B may be deposited to replace the reflective layer(s) such as shown in FIG. 4B.

Additionally, in some aspects of the disclosure, the number of reflective layer(s) may change. For example, initially, two reflective layer(s) 505A, 505B may be used. However, depending on the x-ray and density estimate, it may be determined that the top reflective layer 505B may not be needed.

At S208-5, the power level for the microwave source 10 may be determined, e.g., new power level. The power level may be based on the x-ray evaluation. For example, if the evaluation shows that the center of the preform 500 is achieving the densification, the power level may be increased to speed up the reaction. Since the thermal conductivity κₚ is expected to increase, the increase in the power may not necessarily increase the temperature inversion ΔT.

The temperature inversion ΔT may be increased by cooling the surface of the preform 500 such as via convection cooling. This may be accomplished by increasing the gas flow rates.

At S208-7, the processor 8 causes the microwave source 10 to emit the microwaves 510 using the determined power level in S208-5 (and set frequency in S208-3) in a similar manner as described above.

The monitoring may be periodically executed. For example, the monitoring may be done after each 24 hours of processing.

FIG. 8B illustrates a flow diagram of another method for monitoring the M-CVI process and feedback control in accordance with aspects of the disclosure. The method illustrated in FIG. 8B may be used where the microwave source 10 may emit a single main frequency (such as a magnetron) whereas the method illustrated in FIG. 8A may be used where the microwave source 10 can emit different main frequencies (such as a solid-state microwave generator).

At S208-1, the properties of the preform 500 are estimated as described above. Here since the frequency of the microwave source 10 cannot be changed, in order to minimize the change in the ratios, e.g., characteristic wavelength λ_{c} and penetration depth Lₚ, the thickness of the preform T is changed. The reflective layer(s) 505A, 505B are disassociated with the preform 500, e.g., removed. For example, the deposited layer(s) may be cut. The reflective layer(s) 505A, 505B may be removed from the holder(s) 22 and separated from the preform 500. In some aspects, the reflective layer(s) 505A, 505B may be removed prior to x-ray.

Depending on the change in the characteristic wavelength w and penetration depth Lₚ, (for the emitted frequency), the preform 500 may need to be made thicker or thinner at S208-22. To make the preform 500 thinner, the preform 500 may be cut, such as in half, in the z direction. To make the preform 500 thicker, the preform 500 may be cut such as in the x or y direction and the parts stacked.

Once the new thickness is achieved, the preform 500 may be newly associated with a reflective layer(s) 505A, 505B in S202_A in a similar manner as described above. At S208-5, the power level for the microwave source 10 may be determined, e.g., new power level and at S208-24, the processor 8 causes the microwave source 10 to emit the microwaves 510 using the determined power level in S208-5.

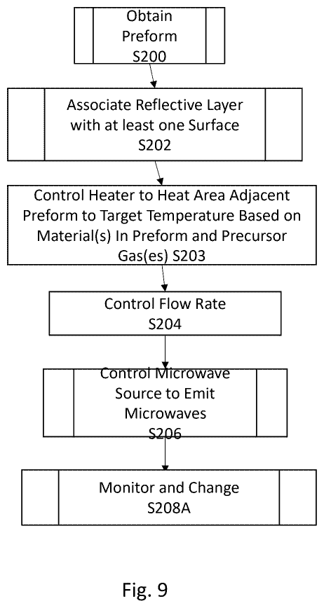

FIG. 9 illustrates a flow diagram of another M-CVI method in accordance with aspects of the disclosure. The difference between the method illustrated in FIG. 9 and the method illustrated in FIG. 2 is that in FIG. 9 there are two sources of heat whereas in FIG. 2, microwaves 510 is the only source of heat. Thus, S203 is added in the method illustrated in FIG. 9 and fabrication is in the M-CVI system 1A depicted in FIG. 1B.

The method illustrated in FIG. 9 may be used where the precursor gases require a temperature greater than 900° C. to undergo pyrolysis. For example, methyltrichlorosilane (MTS) (CH₃SiCl₃), dimethyldichlorosilane (Si(CH₃)2Cl₂), and methyldichlorosilane (SiHCH₃Cl₂) need a temperature greater than about 900° C. to undergo pyrolysis. The higher the temperature, the faster the reaction time is, however, at a higher temperature, the premature pore closure is an issue. In accordance with aspects of the disclosure, the surface temperature may be initially set to the lower end of the range (about 900°-925° C.). The range may include 900°-1200° C. The processor 32 may control the heater 26 to heat to a target temperature to achieve the target surface temperature Ts. Since the preform 500 in this aspect of the disclosure is heated by both the heater 26 and the microwave source 10, the target air temperature may be less than the target surface temperature Ts. While the reaction is slower at this temperature, it is expected that a target residual porosity will be able to be reached is a shorter amount of time than known CVI system because of the temperature inversion caused by the microwaves 510. In order to achieve the inside out densification, the temperature inversion ΔT should be greater than a threshold. The threshold may be different for different reactions (combination of precursor gases and preform 500). In some aspects, the temperature inversion ΔT should be greater than 20° C. In other aspects, the temperature inversion ΔT should be greater than 25° C. The temperature inversion ΔT should be greater than 50° C. The power level of the microwave source in combination with the reflective layers 505A, 505B causes the temperature inversion ΔT. For example, the microwave power may be between 3-12 W/cm². The power level may be lower because the use of the heater 26, which both heats the air adjacent to the preform 500 and heats the preform 500. For some reactions, a higher microwave power coupled with a lower surface temperature may achieve the target residual porosity yet still have a reduced processing time.

In some aspects of the disclosure, the surface temperature Ts may be increased in S208A by either increasing the power to either the heater 26, the microwave source 10 or a combination of both. Similar to above, the M-CVI process may be monitored periodically. The monitoring may cause the power level to change, the set temperature for the heater, the frequency of the microwave source emission, and/or the reflective layer(s) used in a similar manner as described above. While increasing the surface temperature Ts may increase the likelihood of premature pore closure, since there would still be a temperature inversion ΔT, and the densification occurs inside out, it is expected that there may only be a minimal drop in the residual porosity, but it would dramatically speed on the process.

Provisional application Ser. No. 63/567,910 describes and illustrates simulations in accordance with aspects of the disclosure. This description is incorporated by reference herein.

Various aspects of the present disclosure may be embodied as a program, software, or computer instructions embodied or stored in a computer or machine usable or readable medium, or a group of media which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided, e.g., a computer program product.

The computer readable medium could be a computer readable storage device or a computer readable signal medium. A computer readable storage device may be, for example, a magnetic, optical, electronic, electromagnetic, infrared, or semiconductor system, apparatus, or device, or any suitable combination of the foregoing; however, the computer readable storage device is not limited to these examples except a computer readable storage device excludes computer readable signal medium. Additional examples of the computer readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an optical storage device, or any appropriate combination of the foregoing; however, the computer readable storage device is also not limited to these examples. Any tangible medium that can contain, or store, a program for use by or in connection with an instruction execution system, apparatus, or device could be a computer readable storage device.

A computer readable signal medium may include a propagated data signal with computer readable program code embodied therein, such as, but not limited to, in baseband or as part of a carrier wave. A propagated signal may take any of a plurality of forms, including, but not limited to, electro-magnetic, optical, or any suitable combination thereof. A computer readable signal medium may be any computer readable medium (exclusive of computer readable storage device) that can communicate, propagate, or transport a program for use by or in connection with a system, apparatus, or device. Program code embodied on a computer readable signal medium may be transmitted using any appropriate medium, including but not limited to wireless, wired, optical fiber cable, RF, etc., or any suitable combination of the foregoing.

The terminology used herein is for the purpose of describing particular aspects only and is not intended to be limiting the scope of the disclosure and is not intended to be exhaustive. Many modifications and variations will be apparent to those of ordinary skill in the art without departing from the scope and spirit of the disclosure.

What is claimed is:

1. A manufacturing system comprising:
reactor comprising:
a chamber configured to hold at least one porous preform, each porous preform having a first surface and a second surface opposite to the first surface;
a means to associate a reflective layer on at least one of the first surface or the second surface;
at least one gas inlet configured to deliver at least one precursor gas to the chamber; and
a gas outlet;
a microwave source configured to emit microwaves in at least one wavelength;
a waveguide being connected between the microwave source and the reactor, the waveguide being positioned to enable the microwaves to enter each porous preform either at the first surface or the second surface; and
one or more processors configured to:
control a gas flow rate of the at least one precursor gas through the at least one gas inlet; and
control the microwave source based on properties of a porous preform to create a temperature inversion within the porous preform such that a temperature midway between the first surface and the second surface is larger than the temperature at the first surface and the second surface by a value while the at least one precursor gas flows in the chamber at a predetermined pressure.

2. The manufacturing system of claim 1, wherein the chamber further comprises a heater configured to heat each porous preform such that the first surface or the second surface is at a temperature, where the temperature is based on properties of each porous preform.

3. The manufacturing system of claim 1, wherein the reflective layer is removably attached to the means.

4. The manufacturing system of claim 3, further comprising a plurality of reflective layers which is selectable based on the porous perform.

5. The manufacturing system of claim 1, wherein the means associates the reflective layer with both the first surface and the second surface.

6. The manufacturing system of claim 1, wherein the microwave source is configured to emit microwaves in a plurality of wavelengths, wherein a wavelength for emission is selected to achieve a characteristic wavelength of a resonant mode within the porous preform, the characteristic wavelength having predetermined proportion to a thickness of the porous preform (T) between the first surface and the second surface.

7. The manufacturing system of claim 6, wherein
the characteristic wavelength of the resonant mode within the porous preform is based on a permittivity εₚ of the porous preform; and
one or more processors are configured to change the wavelength selected for emission to reduce a change of the characteristic wavelength as the permittivity εₚ of the porous preform changes during a densification of the porous preform.

8. A method for densifying a porous preform, the method comprising:
obtaining the porous preform, the porous preform having a first surface and a second surface in a first direction, the first surface and the second surface being separated by a distance (T) in the first direction, the porous preform comprising a ceramic that is reactive with chemical vapor infiltration (CVI) precursor gases, the ceramic having a porosity Φₚ and a permittivity εₚ;
associating a reflective layer with at least one of the first surface or the second surface, the reflective layer having a thickness (tᵣ) which is much less than the distance T, wherein the reflective layer comprises a material that is non-reactive to the CVI precursor gases, has a porosity Φᵣ and a permittivity εᵣ; the porosity Φᵣ of the reflective layer is larger than the porosity Φₚ of the ceramic and the permittivity εᵣ of the reflective layer is larger than the permittivity εₚ of the ceramic such that microwaves are caused to have a phase shift of 180°;
controlling a flow rate of the precursor gases into a CVI reactor to cause the precursor gases to diffuse inside the porous preform; and
controlling a microwave source to emit microwaves having a wavelength λₘ and direct the microwaves toward either the first surface or the second surface of the porous preform, which is positioned in the CVI reactor, whereby the microwave enter an inside of the porous preform and form a resonant mode which creates a temperature inversion such that a temperature midway between the first surface and the second surface is larger than the temperature at the first surface and the second surface by a value.

9. The method for densifying a porous preform of claim 8, further comprising:
heating the CVI reactor to a temperature such that the temperature of the first surface or the second surface is a first temperature which is based on the porous perform and the precursor gases.

10. The method for densifying a porous preform of claim 9, wherein the distance Tis set such that a characteristic wavelength of the resonant mode within the porous preform responsive to the wavelength λₘ is a predetermined proportion.

11. The method for densifying a porous preform of claim 10, further comprising:
cutting and/or stacking the porous preform at a time during the method to reduce a change in the characteristic wavelength of the resonant mode within the porous preform responsive to the wavelength λₘ.

12. The method for densifying a porous preform of claim 9, wherein the wavelength λₘ is set such that a characteristic wavelength of the resonant mode within the porous preform responsive to the wavelength λₘ is a predetermined proportion of the distance T.

13. The method for densifying a porous preform of claim 12, further comprising:
changing the set wavelength λₘ during a densification to reduce a change in the characteristic wavelength of the resonant mode within the porous preform.

14. The method for densifying a porous preform of claim 9, wherein in a case where the reflective layer is associated with the first surface or the second surface, the microwaves are directed to the other of the first surface or the second surface.

15. The method for densifying a porous preform of claim 9, wherein the associating a reflective layer with at least one of the first surface or the second surface comprises selecting a first reflective layer from a plurality of prefabricated reflective layers based on the porous preform and the precursor gases and attaching the selected first reflective layer to a structure within the CVI reactor to hold the first reflective layer in contact with the first surface or the second surface of the porous preform.

16. The method for densifying a porous preform of claim 15, wherein the associating a reflective layer with at least one of the first surface or the second surface further comprises selecting a second reflective layer from the plurality of prefabricated reflective layers based on the porous preform and the precursor gases and attaching the second reflective layer selected to a structure within the CVI reactor to hold the second reflective layer in contact with the other of the first surface or the second surface of the porous preform.

17. The method for densifying a porous preform of claim 16, wherein one the first reflective layer or the second reflective layer comprises an anti-reflective coating on a surface in which the microwaves enter.

18. The method for densifying a porous preform of claim 9, wherein the material comprises SiC and the reflective layer comprises BaTiO₃ or TiO₂.

19. The method for densifying a porous preform of claim 17, wherein the anti-reflective coating is formed from a powder comprising Al₂O₃.

20. The manufacturing system of claim 1, wherein the reflective layer has properties to cause the microwaves to have a phase shift of 180°.

21. The manufacturing system of claim 1, further comprising a pressure regulator configured to control the pressure within the chamber to reach the predetermined pressure.

22. The manufacturing system of claim 2, wherein a same processor controls the microwave source and the heater.

23. The manufacturing system of claim 1, wherein the means comprises one or more mechanical arms.
